(19) United States
(12) Patent Application Publication
(10) Pub. No.: US 2012/0293132 A1
(43) Pub. Date: Nov. 22, 2012

(54) REMAINING CAPACITY CALCULATION METHOD, BATTERY PACK PRE-SHIPMENT ADJUSTMENT METHOD, REMAINING CAPACITY CALCULATING DEVICE AND BATTERY PACK

(76) Inventors: Tomomi KAINO, Sumoto-shi (JP); Naofumi Enomoto, Minamiawaji-shi (JP); Atsushi Kawasumi, Sumoto-shi (JP)

(21) Appl. No.: 13/468,306

(22) Filed: May 10, 2012

(30) Foreign Application Priority Data
May 16, 2011 (JP) 2011-109803

(51) Int. Cl. H02J 7/00

(52) U.S. Cl. 320/136

(57) ABSTRACT

A MOSFET 61 is connected between a power supply IC6 and a 3.3-V power supply terminal. When the MOSFET 61 is turned OFF, a control circuit board 100 is shut down which includes a control portion 5 for calculating RSOC (remaining capacity ratio). When the control circuit board 100 returns from shutdown, the maximum cell voltage is detected as OCV (open circuit voltage). RSOC can be calculated based on the maximum cell voltage by using the discharge characteristic which relates OCV to RSOC. In this case, a quadratic curve line segment is selected from an approximate curve line which approximates the discharge characteristics. RSOC can be calculated by substituting the detected maximum cell voltage into the quadratic function which is represented by the selected quadratic curve line segment.

### BACKGROUND OF THE INVENTION

1. Field of the Invention

The present invention relates to a remaining capacity calculating method, a battery pack pre-shipment adjustment method, a remaining capacity calculating device, and a battery pack which calculate the remaining capacity of a rechargeable battery by using a circuit switched between ON and OFF based on a shutdown command, for example.

2. Description of the Related Art

In battery packs which include a control portion for controlling the charging/discharging operation of a rechargeable battery, remaining capacity integration, and the like, the remaining capacity is periodically calculated based on the discharging/charging current which includes the consumption current consumed by the control portion. In the battery packs, the rechargeable battery is continuously discharged at a small amount of current to provide the current consumed by the control portion. For this reason, on the condition that the battery packs are brought into a non-use state for a long time, the control portion will be shut down to prevent reduction of the remaining capacity of the rechargeable battery and to prevent the rechargeable batteries from being over-discharged. In the case where the battery packs are shut down, the control portion cannot perform not only the remaining capacity integration but also any other processing which is performed before shutdown. Accordingly, it is required to take measures against shutdown.

For example, Japanese Patent Laid-Open Publication No. JP 2007-228,703 A discloses a battery pack which calculates elapsed time after a rechargeable battery is brought into an over-discharged state. The battery pack stores the date and time when the rechargeable battery is brought into an over-discharged state in a nonvolatile memory, before being shut down. After that, when the battery pack is connected to an external electric device and returns from shutdown, the battery pack obtains the date and time from the electric device. Thus, the battery pack sets the obtained return date and time from the shutdown state to the return date and time from the over-discharged state.

Japanese Patent Laid-Open Publication No. JP 2009-112,180 A discloses a similar battery pack. The battery pack obtains the date and time through a radio-controlled clock included in the battery pack.

However, in the battery packs disclosed in JP 2007-228,703 A and JP 2009-112,180 A, in the case where the battery packs are shut down, the rechargeable battery is continuously discharged due to self-discharging. For this reason, when the battery packs return from the shutdown state after sitting unused for a relatively long time, a problem will arise that the difference is non-negligible between the remaining capacity stored at the shutdown and the actual remaining capacity at the return.

The present invention is aimed at solving the problem. It is an object of the present invention to provide a remaining capacity calculation method, and a battery pack pre-shipment adjustment method capable of calculating the remaining capacity of a rechargeable battery with small difference between the calculated remaining capacity and the actual remaining capacity when the battery returns from shutdown after sitting unused (shutdown). Also, it is another object of the present invention to provide a remaining capacity calculating device capable of calculating the remaining capacity of a rechargeable battery with small difference between the calculated remaining capacity and the actual remaining capacity when the battery returns from shutdown after sitting unused, and a battery pack including this remaining capacity calculating device.

### SUMMARY OF THE INVENTION

A method according to an aspect of the present invention calculates the remaining capacity of a rechargeable battery by using a calculation portion that is switched between ON and OFF. The open voltage of the rechargeable battery is obtained after the calculation portion is switched from OFF to ON. The remaining capacity of the rechargeable battery is calculated based on the obtained open voltage.

In a remaining capacity calculating method according to another aspect of the present invention, the discharge characteristic can be stored which represents the relationship between the open voltage and the capacity of the rechargeable battery. The remaining capacity of the rechargeable battery can be calculated based on the stored discharge characteristic and the obtained open voltage.

A remaining capacity calculating method according to another aspect of the present invention stores the remaining capacity of a rechargeable battery, and calculates the remaining capacity of the rechargeable battery by using a calculation portion that is switched between ON and OFF. Date and time data is obtained before and after the calculation portion is brought OFF. A correction capacity is calculated which is adjusted larger or smaller based on whether the difference between the obtained date and time data is larger or smaller. The remaining capacity of the rechargeable battery is calculated by subtracting the calculated correction capacity from the stored remaining capacity.

In a battery pack pre-shipment adjustment method according to another aspect of the present invention, a battery pack is produced which calculates the remaining capacity of the rechargeable battery by using the aforementioned remaining capacity calculating method. The calculation portion is switched ON after the produced battery pack is charged from the external side before shipment. After that, the calculation portion is switched from ON to OFF.

A rechargeable battery remaining capacity calculating device according to another aspect of the present invention includes a calculation portion that is switched between ON and OFF, and calculates the remaining capacity of a rechargeable battery. The device includes an open-voltage obtainer that obtains the open voltage of the rechargeable battery after the calculation portion is switched from OFF to ON. The remaining capacity of the rechargeable battery is calculated based on the open voltage, which is obtained by the open-voltage obtainer.

A rechargeable battery remaining capacity calculating device according to another aspect of the present invention can include a storage that stores the discharge characteristic which represents the relationship between the open voltage and the capacity of the rechargeable battery. The remaining capacity of the rechargeable battery is calculated based on the discharge characteristic, which is stored by the storage, and the open voltage, which is obtained by the open-voltage obtainer.

A rechargeable battery remaining capacity calculating device for calculating the remaining capacity of a rechargeable battery according to another aspect of the present invention includes a calculation portion that stores the remaining capacity of the rechargeable battery and is switched between ON and OFF. The device includes a date-and-time obtainer, and a calculator. The date-and-time obtainer obtains date and time data before and after the calculation portion is brought OFF. The calculator calculates a correction capacity which is adjusted larger or smaller based on whether the difference between the obtained date and time data is larger or smaller. The remaining capacity of the rechargeable battery is calculated by subtracting the correction capacity, which is calculated by the calculator, from the stored remaining capacity.

A battery pack according to the present invention includes the aforementioned remaining capacity calculating device, and one or more rechargeable batteries the remaining capacity of which is calculated by the remaining capacity calculating device.

According to the present invention, a control portion includes the calculation portion for calculating the remaining capacity, and newly calculates the remaining capacity of the rechargeable battery in accordance with the open voltage of the rechargeable battery which is obtained after returning from shutdown.

That is, the capacity can be calculated so as to be adjusted larger or smaller based on whether the open voltage of the rechargeable battery is higher or lower at the return from shutdown even if the shutdown period is longer or shorter.

According to the present invention, the remaining capacity can be calculated based on the open voltage of the rechargeable battery, which is obtained at return from shutdown, by using the discharge characteristic which relates the open voltage to the capacity.

Thus, in the case where the open voltage and the capacity of the rechargeable battery have a certain relationship, it is possible to accurately calculate the remaining capacity at return from shutdown.

According to the present invention, a control portion includes the calculation portion for calculating the remaining capacity, and can calculate a correction capacity for correcting the remaining capacity so as to adjust the correction capacity higher or lower based on whether the difference of the date and time data is larger or smaller, which are obtained before shutdown and after return from the shutdown. Thus, the remaining capacity can be obtained by subtracting the correction capacity from the remaining capacity which is stored before shutdown.

Thus, the control portion can calculate the reduction amount for reducing the stored remaining capacity so as to adjust the reduction amount larger or lower based on whether the shutdown period is longer or shorter.

According to the present invention, the remaining capacity of the rechargeable battery can be calculated by the aforementioned remaining capacity calculating device.

The battery pack can be provided with the remaining capacity calculating device capable of calculating the remaining capacity with small difference between the calculated remaining capacity and the actual remaining capacity when the battery returns from shutdown after sitting unused (shutdown) for a relatively long time.

According to the present invention, after being produced, the battery pack is charged before shipment. Subsequently, the calculation portion is switched from OFF to ON, and is then switched OFF in the pre-shipment adjustment. Accordingly, even if the battery pack sits unused for a long time after the shipment, it is possible to accurately calculate the remaining capacity when the battery pack starts operating.

### Effects of the Invention

According to the present invention, the control portion newly calculates the remaining capacity of a rechargeable battery based on the open voltage of the rechargeable battery at return from shutdown. Thus, the remaining capacity is adjusted larger or smaller based on whether the open voltage of the rechargeable battery is higher or lower at the return from shutdown even if the shutdown period is longer or shorter.

Therefore, it is possible to calculate the remaining capacity of a rechargeable battery with small difference between the calculated remaining capacity and the actual remaining capacity when the battery returns from shutdown after sitting unused (shutdown). For example, in the case where the battery pack sits in stock after shipment from the manufacturer (for example, in the case where the stock period is long), the above effect will be remarkably provided when a user uses the battery pack.

The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram showing the exemplary construction of a battery pack according to a first embodiment of the present invention;

FIG. 2A is a graph schematically showing the battery voltage which varies before and after an unused period;

FIG. 2B is a graph schematically showing the remaining capacity which varies before and after an unused period;

FIG. 2C is a graph schematically showing the operating status of a control portion which changes before and after an unused period;

FIG. 3 is a graph showing the relationship between the open circuit voltage of one battery cell which composes the rechargeable battery and the remaining capacity ratio;

FIG. 4 is a graph showing a plurality of approximate curve lines which approximate the discharge characteristics of OCV-RSOC;

FIG. 5 is a flowchart showing the procedure of a CPU which calculates RSOC when the battery pack according to the first embodiment of the present invention returns from shutdown;

FIG. 6 is a flowchart showing the procedure of the CPU which executes processing based on a command received through a communication portion;

FIG. 7 is a flowchart showing the procedure of the CPU which executes processing based on a command received through the communication portion in a battery pack according to a second embodiment of the present invention; and

FIG. 8 is a flowchart showing the procedure of the CPU which executes processing based on a command received through the communication portion in a battery pack according to the second embodiment of the present invention.

### DETAILED DESCRIPTION OF THE EMBODIMENT(S)

The following description will describe embodiments according to the present invention with reference to the drawings.

### First Embodiment

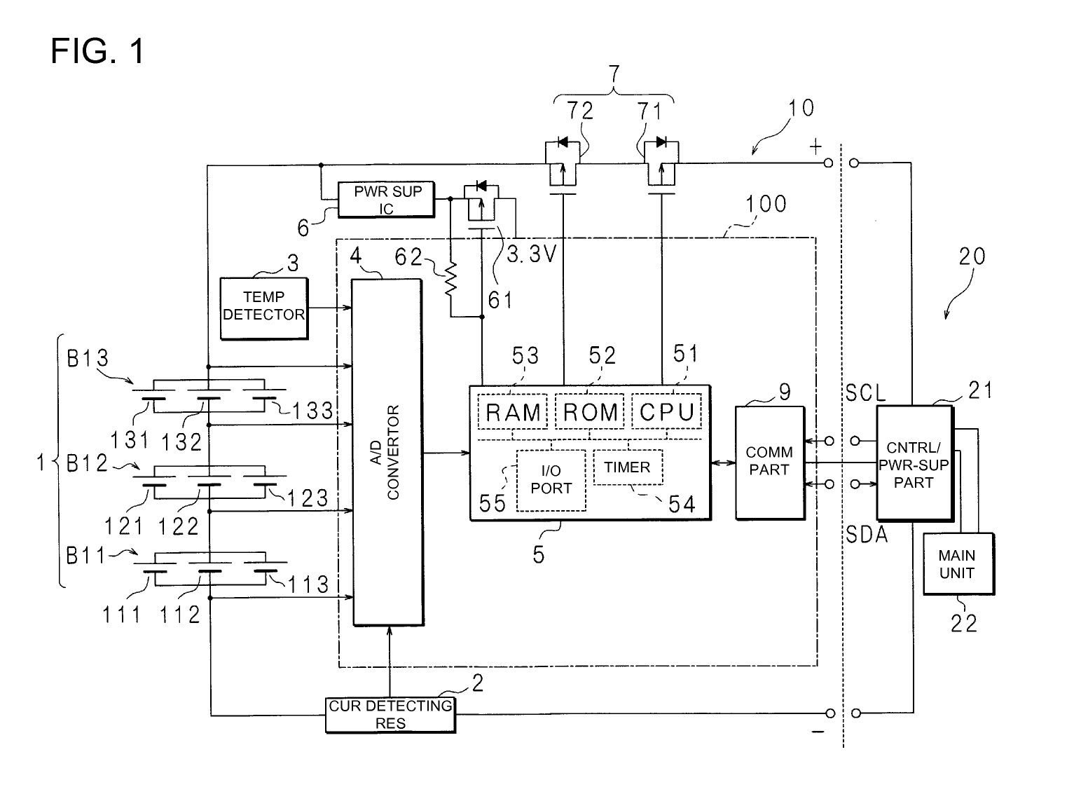

FIG. 1 is a block diagram showing the exemplary construction of a battery pack according to a first embodiment of the present invention. The battery pack includes a battery pack 10. The battery pack 10 is detachably attached to an electric device 20 such as personal computer (PC) and personal digital assistant. The battery pack 10 includes a rechargeable battery 1. The battery 1 includes battery blocks B11, B12 and B13 that are serially connected to each other in this order. Each of the battery blocks B11, B12 and B13 includes three battery cells of lithium-ion batteries 111, 112 and 113, 121, 122 and 123, or 131, 131 and 131 that are connected to each other in parallel. The positive terminal of the battery block B13 and the negative terminal of the battery block B11 serve as the positive terminal and the negative terminal of the rechargeable battery 1, respectively.

The voltages of the battery blocks B11, B12 and B13 are independently provided to an analog input terminal of an A/D conversion portion 4, and are converted into digital voltage values. The converted voltage values are provided from a digital output terminal of the A/D conversion portion 4 to a control portion 5 composed of a microcomputer. In addition, the analog input terminal of the A/D conversion portion 4 is provided with the detection output of a temperature detector 3, and the detection output of a current detecting resistor 2. The temperature detector 3 is arranged in proximity to the rechargeable battery 1, and detects the temperature of the rechargeable battery 1 by means of a circuit including a thermistor. The current detecting resistor 2 is connected to the negative terminal of the rechargeable battery 1 on the charging/discharging line, and detects the charging/discharging current of the rechargeable battery 1. These detection outputs are converted into digital detecting values, and are provided from the digital output terminal of the A/D conversion portion 4 to the control portion 5.

A cutoff portion 7 is connected to the positive terminal side of the rechargeable battery 1 on the charging/discharging line. The cutoff portion 7 is composed of P-channel type MOSFETs 71 and 72 that cut off charging current and discharging current, respectively. The MOSFETs 71 and 72 are serially connected to each other with their drain terminals being directly connected to each other. Diodes are shown between the drain and source terminals of the MOSFETs 71 and 72. The diodes correspond to parasitism diodes (body diodes) of the MOSFETs 71 and 72. An input terminal of a power supply (regulator) IC6 is connected to the positive terminal side of the rechargeable battery 1 on the charging/discharging path. A 3.3V-power supply input terminal of a control circuit board 100 is provided through the source and drain electrodes of a P-channel type MOSFET 61 with DC power of 3.3V which is stabilized by the power supply IC6. The control circuit board 100 includes a control portion 5. A resistor 62 is connected between the source and gate electrodes of the MOSFET 61.

The control portion 5 includes a CPU 51. The CPU 51 is connected via the bus to a ROM 52, a RAM 53, a timer 54, and an I/O port 55. The ROM 52 stores information such as program. The RAM 53 temporarily stores created information. The timer 54 counts time. The I/O Port 55 provides/receives signals to/from portions of the battery pack 10. The I/O Port 55 is connected to the digital output terminal of the A/D conversion portion 4, the gate electrodes of the MOSFETs 71, 72 and 61, and a communication portion 9. The communication portion 9 communicates with a control/power-supply portion 21 (charger) included in the electric device 20. The ROM 52 is a nonvolatile memory composed of EEPROM (Electrically Erasable Programmable ROM) or flash memory. The ROM 52 stores a learning value (=learning capacity) of full charge capacity (FCC), the number of charging/discharging cycles, various types of stored data such as remaining capacity and date and time data, and various types of setting data in addition to the program.

A remaining capacity calculating device is composed of at least the control circuit board 100, which includes the A/D conversion portion 4, the control portion 5 and the resistor 62, and the current detecting resistor 2, the power supply 106, and the MOSFET 61.

The CPU 51 executes processing including calculation, providing/receiving and the like based on the control program previously stored in the ROM 52. For example, the CPU 51 reads the voltage values of the battery blocks B11, B12 and B13, and the detected value of the charging/discharging current of the rechargeable battery 1 periodically (e.g., at 250 msec), and calculates the remaining capacities of the rechargeable battery 1 based on the read voltage values and detected values. The CPU 51 stores the calculated remaining capacity value in the RAM 53. The CPU 51 determines the maximum voltage value (hereinafter, also referred to as the maximum cell voltage) among the read voltage values of the battery blocks B11, B12 and B13, and stores the maximum cell voltage in the RAM 53. The reading cycle of the voltage values and the detection values of the charging/discharging current is not limited to 250 msec. Also, the CPU 51 creates remaining capacity data, and writes the created data in a register (not shown) in the communication portion 9. Thus, the remaining capacity data can be provided from the communication portion 9.

The drain and source electrodes of the MOSFETs 71 and 72 of the cutoff portion 7 are electrically connected to each other, when the gate electrodes of the MOSFETs 71 and 72 are provided with ON signals of L (low) level from the I/O Port 55 in normal charging/discharging operation. In the case where the charging current of the rechargeable battery 1 is cut off, the drain and source electrodes of the MOSFET 71 are electrically disconnected from each other, when the gate electrode of the MOSFET 71 is provided with an OFF signal of H (high) level from the I/O Port 55. Similarly, in the case where the discharging current of the rechargeable battery 1 is cut off, the drain and source electrodes of the MOSFET 72 are electrically disconnected from each other, when the gate electrode of the MOSFET 72 is provided with an OFF signal of H (high) level from the I/O Port 55. In the case where the rechargeable battery 1 is properly charged, when the rechargeable battery 1 is discharged, at least the MOSFET 72 is brought ON. When the discharging current is large, the MOSFET 71 can be also brought ON.

The electric device 20 includes a main unit 22 which is connected to the control/power-supply portion 21. The control/power-supply portion 21 is supplied with electric power from commercial power (not shown) to drive the main unit 22 and to supply the charging current onto the charging/discharging path of the rechargeable battery 1. If electric power stops being supplied from commercial power to the control/power-supply portion 21, the main unit 22 can be driven by the discharging current which is supplied through the charging/discharging path of the rechargeable battery 1. In the case where the rechargeable battery 1 to be charged by the control/power-supply portion 21 is a lithium ion battery, the rechargeable battery 1 is charged in a constant-current (MAX current about 0.5 to 1 C) and constant-voltage (MAX about 4.2 to 4.4V per battery cell) charging manner in which the maximum current and the maximum voltage are regulated. If the battery voltage of the rechargeable battery 1 reaches a predetermined value and the charging current keeps not lower than a predetermined value for a predetermined period, it can be determined that the rechargeable battery 1 is fully charged.

The control/power-supply portion 21 and the communication portions 9 communicate with each other in the SMBus (System Management Bus) manner. The control/power-supply portion 21 serves as server, while the communication portion 9 serves as client. In this case, the serial clock (SCL) is provided from the control/power-supply portion 21, while serial data (SDA) is bidirectionally provided and received between the control/power-supply portion 21 and the communication portion 9. In this embodiment, the control/power-supply portion 21 reads the information of the aforementioned register of the communication portion 9 by interrogating the communication portion 9 (polling) periodically at 2 seconds. The control/power-supply portion 21 receives the remaining capacity data of the rechargeable battery 1 from the communication portion 9 periodically at 2 seconds by polling, for example. The remaining capacity data can be displayed as remaining capacity value (%) on a display (not shown) included in the electric device 20.

In this case, the aforementioned polling period 2 seconds is set by the control/power-supply portion 21. It is noted that the communication portion 9 and the control/power-supply portion 21 may communicate with each other in other communication manners.

The remaining capacity of the rechargeable battery 1 is calculated as current integrated amount or electric power integrated amount by subtracting the discharge capacity from the learning capacity (expressed in Ah or Wh) of the rechargeable battery 1. The remaining capacity is expressed as a percentage where the learning capacity is defined 100%. The learning capacity of the rechargeable battery 1 can be the integrated amount of discharging current or discharging power from the fully discharged state to the state where the rechargeable battery 1 is discharged to a discharge stop voltage. Also, the learning capacity of the rechargeable battery 1 can be the integrated amount of charging current or charging power from the state where the rechargeable battery 1 is discharged to the discharge stop voltage to the fully discharged state. The control portion 5 continuously consumes hundreds μA of current even when only calculating the remaining capacity. For this reason, when the battery voltage of the rechargeable battery 1 decreased to the discharge stop voltage, the control circuit board 100 is shut down in order to prevent that the rechargeable battery 1 is over-discharged. After the control portion 5 is shut down, the leak current from the rechargeable battery 1 can be reduced to about 30 μA. In this embodiment, the control circuit board 100 is shut down at shipment of the battery pack 10.

In the case where the CPU 51 shuts the control circuit board 100 down, the OFF signal of H level is provided to the gate electrode of the MOSFET 61 through the I/O Port 55. In the case where the control circuit board 100 is shut down, the gate and source electrodes of the MOSFET 61, which is connected to the output terminal of the power supply IC6, are connected to each other through the resistor 62 so that the gate and source electrodes will have the same potential. Thus, the MOSFET 61 is held OFF. When the control/power-supply portion 21 starts charging the rechargeable battery 1, the gate electrode of the MOSFET 61 is provided with the ON signal of L level from a circuit (not shown) so that the MOSFET 61 is forcedly turned ON. Thus, the control circuit board 100 returns from shutdown. Immediately after the CPU 51 of the control portion 5 starts operating, the gate electrode of the MOSFET 61 is continuously provided with the ON signal of L level from the I/O Port 55.

The following description will describe the status change during the battery pack 10 sits unused after the control circuit board 100 is shut down. The control circuit board is shut down before the battery pack is shipped after the battery pack is manufactured and then charged.

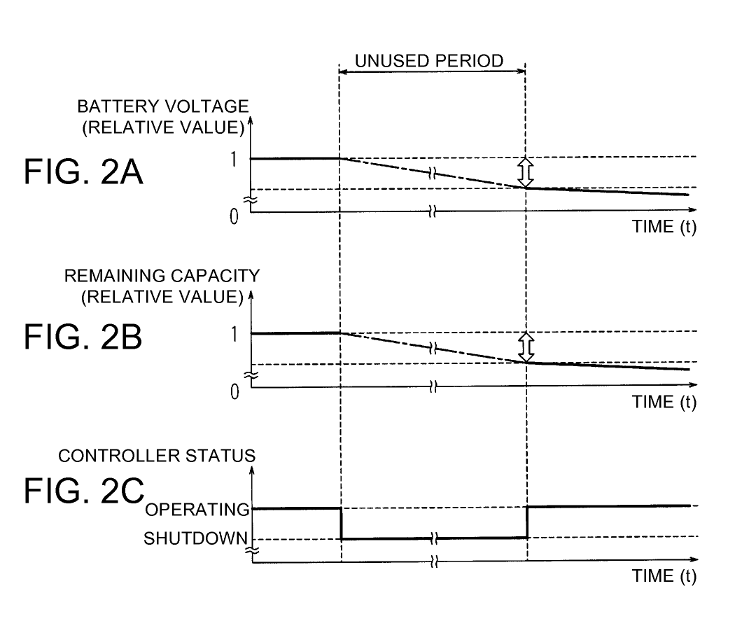

FIG. 2A is a graph schematically showing the battery voltage which varies before and after the unused period. FIG. 2B is a graph schematically showing the remaining capacity which varies before and after the unused period. FIG. 2C is a graph schematically showing the status of the control portion 5 which changes before and after the unused period. In the graphs, the horizontal axis represents time (t), while the vertical axes represent the battery voltage (relative value), the remaining capacity (relative value), and the status of the control portion 5. In the example shown in FIG. 2, the rechargeable battery 1 is charged before the unused period, and is then discharged at the start of use after the unused period. It is noted that the time in the unused period on the time axis is suitably compressed in scale.

As shown in FIG. 2C, the control portion 5 is brought in the operating status before the unused period, and is changed into the shutdown status at the start of the unused period. After that, the control portion 5 returns from the shutdown status and is again brought into the operating status at the end of the unused period.

The battery voltage and the remaining capacity of the rechargeable battery 1 gradually decrease by the length of the open arrows as shown in FIGS. 2A and 2B due to self-discharging during the unused period. Generally, the decrease rates of the battery voltage and the remaining capacity in this unused period are not constant, in other words, the battery voltage and the remaining capacity in this unused period do not linearly vary. The decrease rates of the battery voltage and the remaining capacity in this unused period will vary in accordance with elapsed time. The battery voltage and the remaining capacity in the use period after the unused period decrease at rates in accordance with the amount of discharging current.

The relationship between battery voltage and the remaining capacity is now described.

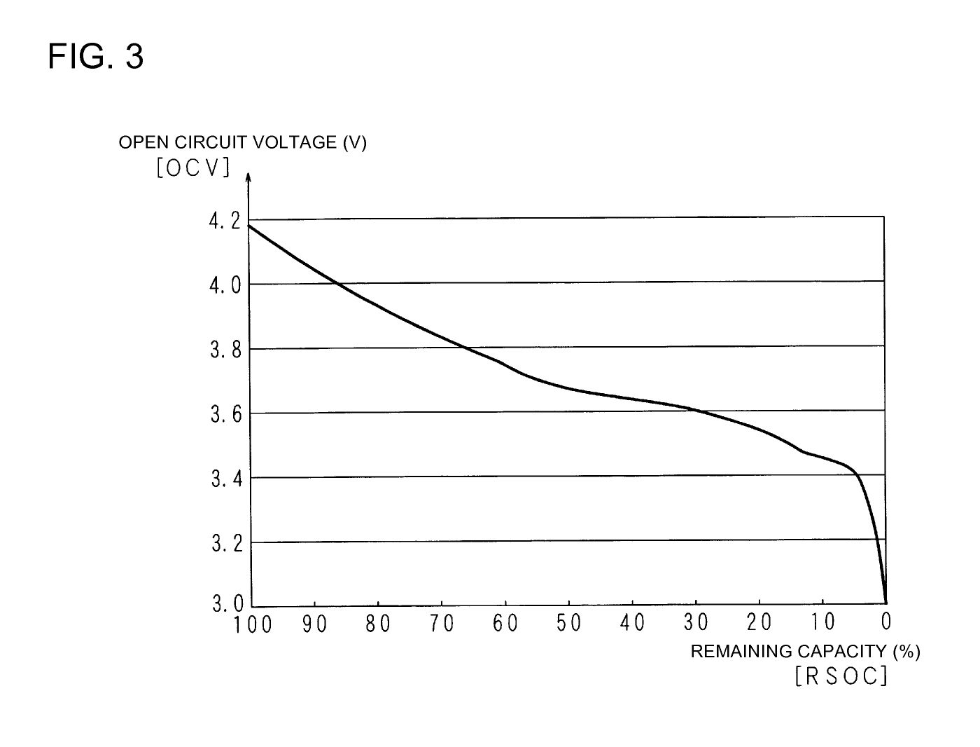

FIG. 3 is a graph showing the relationship between the open circuit voltage of one battery cell which composes the rechargeable battery 1 and the remaining capacity ratio. In this graph, the horizontal axis represents the remaining capacity ratio (hereinafter, also referred to as RSOC; Relative State Of Capacity) (%), which is defined as the ratio of the remaining capacity (RC; Remaining Capacity) to the full charge capacity (FCC), while the vertical axis represents the open circuit voltage (hereinafter, also referred to as OCV) (V).

The inventors have found that neither the temperature nor the deterioration degree of the rechargeable battery 1 has sufficient influence on the discharge characteristic of relationship of RSOC to OCV. Immediately after the control circuit board 100 returns from shutdown, the MOSFETs 71 and 72 of the cutoff portion 7 cut off the charging/discharging path. Accordingly, it can be considered that the battery voltage of the rechargeable battery 1 substantially corresponds to OCV. For this reason, when the control circuit board 100 returns from shutdown, RSOC can be calculated based on the detected battery voltage of the rechargeable battery 1 by using (with reference to) the discharge characteristic of OCV-RSOC shown in FIG. 3. In this first embodiment, although the maximum cell voltage among the battery cells 111, 112, 113, 121, 122, 123, 131,132, and 133 is used as the battery voltage of the rechargeable battery 1, the present invention is not limited to this. For example, the average cell voltage can be used.

The method is specifically now described which uses the terminal voltage of the rechargeable battery 1 with reference to the discharge characteristic of OCV-RSOC.

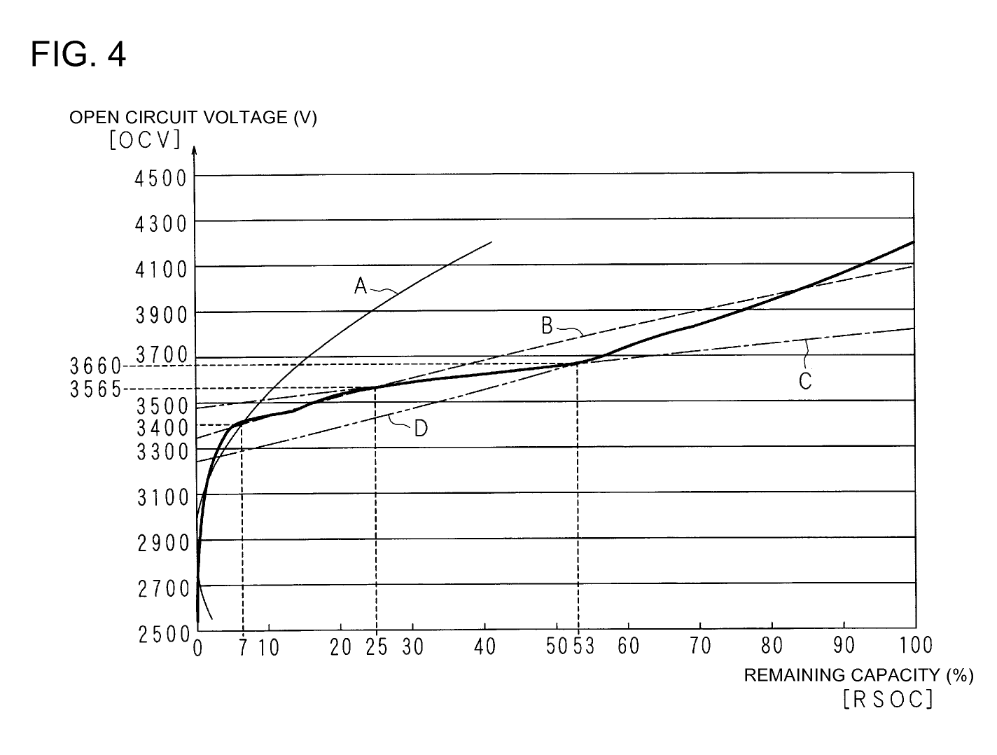

FIG. 4 is a graph showing a plurality of approximate curve lines which approximate the discharge characteristics of OCV-RSOC. In this graph, the horizontal axis represents the remaining capacity ratio (RSOC) (%), while the vertical axis represents the open circuit voltage (OCV) (mV). In FIG. 4, the discharge characteristic of OCV-RSOC is shown by the thick solid line, and is divided into four ranges. The discharge characteristic line segments of OCV-RSOC in the four ranges are approximated by the approximate curve lines A, B, C, and D, which are indicated by the thin solid line, the dashed line, the single-dot-dashed line, and the double-dot-dashed line, respectively, in increasing order of OCV. Although the approximate curve lines A, B, C, and D are quadratic curve lines in this first embodiment, the present invention is not limited to this. For example, the discharge characteristic of OCV-RSOC can be approximated by a plurality of straight lines.

More specifically, the approximate curve line A approximates the discharge characteristics line segment of OCV-RSOC in the range where OCV is smaller than 3400 mV. Also, the approximate curve line B approximates the discharge characteristics line segment of OCV-RSOC in the range where OCV falls within the range larger than 3400 mV and smaller than 3565 mV. Also, the approximate curve line C approximates the discharge characteristics line segment of OCV-RSOC in the range where OCV falls within the range larger than 3565 mV and smaller than 3660 mV. Also, the approximate curve line D approximates the discharge characteristics line segment of OCV-RSOC in the range where OCV is larger than 3660 mV. Thus, the approximated curve lines A, B, C, and D approximated the discharge characteristics line segments of OCV-RSOC in the range where RSOC is smaller than 7%, in the range where RSOC falls within the range of 7% to 25%, in the range where RSOC falls within the range of 25% to 53%, in the range where RSOC is larger than 53%, respectively.

The operation of the aforementioned control portion 5 of the battery pack 10 is now described with reference to flowcharts showing this operation. The following procedures are performed by the CPU 51 based on the control program which is previously stored in the ROM 52.

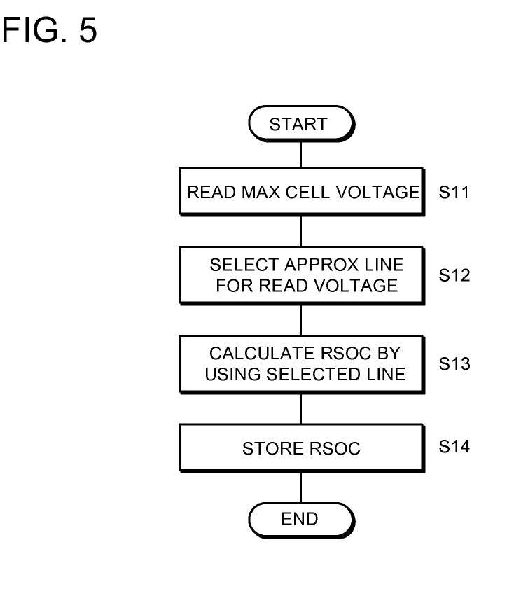

FIG. 5 is a flowchart showing the procedure of the CPU 51 which calculates RSOC when the battery pack 10 according to the first embodiment of the present invention returns from shutdown. The procedure of FIG. 5 starts periodically at 250 msec. However, the cycle of the procedure is not limited to this period. The maximum cell voltage is read from the RAM 53 in the procedure of FIG. 5. This maximum cell voltage to be read is written periodically at 250 msec into the RAM 53.

When the procedure of FIG. 5 starts, the CPU 51 reads the maximum cell voltage from the RAM 53 (S11), and selects one of the four approximate curve lines A, B, C and D shown in FIG. 4 which corresponds to the range in which the read maximum cell voltage falls (S12). Specifically, as shown in FIG. 4, one range is selected based on the maximum cell voltage from the range smaller than 3400 mV, the range larger than 3400 mV and smaller than 3565 mV, the range larger than 3565 mV and smaller than 3660 mV, and the range larger than 3660 mV so that one of the approximate curve lines A, B, C and D is selected based on the range selection.

Subsequently, the CPU 51 calculates RSOC corresponding to the read maximum cell voltage based on the selected approximate curve line (S13). Specifically, RSOC is calculated by substituting the read maximum cell voltage as OCV into the relationship (quadratic function) between OCV and RSOC which is represented by the selected approximate curve line. The CPU 51 stores the calculated RSOC into the RAM 53 and ends procedure of FIG. 5 (S14).

After that, based on a constant-periodic procedure (e.g., 250 msec) (not shown), the CPU 51 correspondingly updates RSOC and stores this updated RSOC into the RAM 53.

The following description describes a procedure for transmitting the RSOC data from the communication portion 9, and a procedure for shutdown.

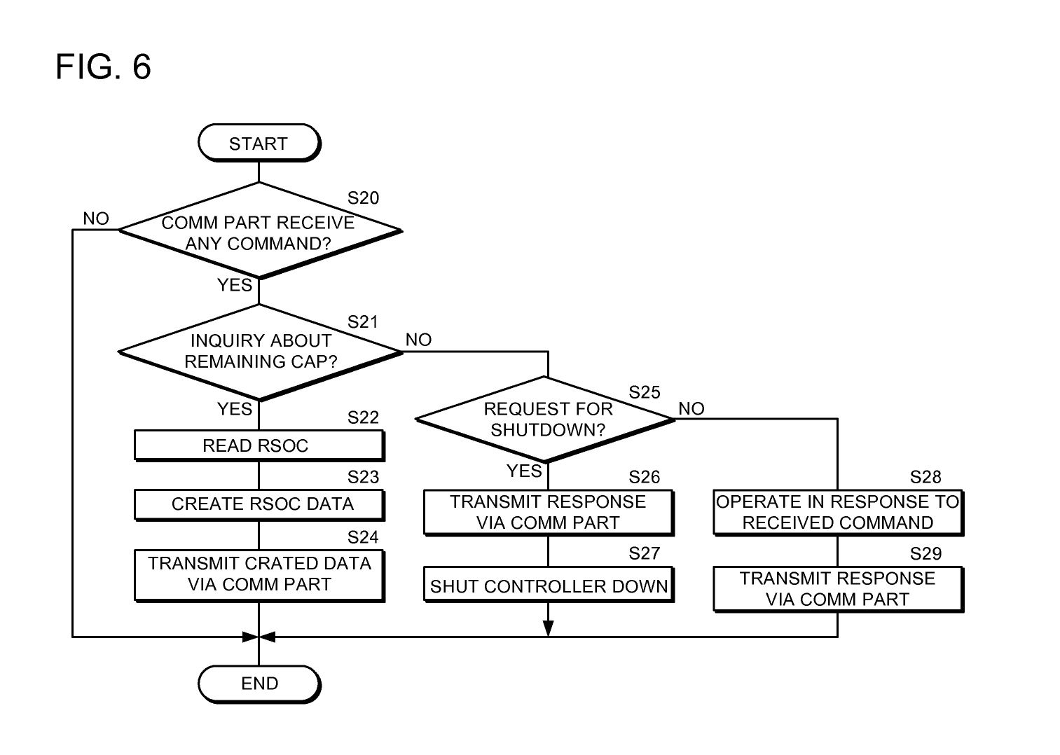

FIG. 6 is a flowchart showing the procedure of the CPU 51 which executes processing based on a command received from the communication portion 9. The procedure of FIG. 6 starts periodically at a period (e.g., 1 sec) shorter than the polling period interrogated by the control/power-supply portion 21. However, the present invention is not limited to this period.

When the process shown in FIG. 6 starts, the CPU 51 determines whether the communication portion 9 receives any command (S20). If no command is received (S20: NO), the procedure FIG. 6 ends. If any command is received (S20: YES), the CPU 51 determines whether the received command is an inquiry command about remaining capacity (S21). If the received command is the inquiry command (S21: YES), the CPU 51 reads RSOC which is stored in the RAM 53 (S22), and creates the RSOC data (S23). Subsequently, the created data is transmitted from the communication portion 9 (S24). After that, the procedure of FIG. 6 ends.

If it is not determined in Step S21 that the received command is the inquiry about remaining capacity (S21: NO), the CPU 51 determines whether the received command is a request command for shutdown (S25). If the received command is a request command for shutdown (S25: YES), the CPU 51 transmits a response to the aforementioned request command through the communication portion 9 (S26). Subsequently, the gate electrode of the MOSFET 61 is provided with the OFF signal of H level through the I/O Port 55. Thus, the MOSFET 61 is turned OFF. The power supply IC6 and the control circuit board 100 are disconnected from each other so that the control circuit board 100 is shut down (S27). After that, the CPU 51 ends the procedure of FIG. 6.

If it is not determined in Step S25 that the received command is the request command for shutdown (S25: NO), the CPU 51 performs other processing corresponding to the received command (S28). Subsequently, a response is transmitted through the communication portion 9 (S29). After that, the procedure of FIG. 6 ends.

As discussed above, according to this embodiment, the control circuit board includes the control portion for calculating RSOC, and newly calculates RSOC of the rechargeable battery in accordance with the maximum cell voltage which is detected after returning from shutdown. That is, RSOC is calculated so as to be adjusted larger or smaller based on whether OCV at the return from shutdown is higher or lower even if the shutdown period of the control portion is longer or shorter.

Therefore, it is possible to calculate the remaining capacity of a rechargeable battery with small difference between the calculated remaining capacity and the actual remaining capacity when the battery returns from shutdown after sitting unused (shutdown).

Also, RSOC can be calculated based on the maximum cell voltage, which is detected at return from shutdown, by using the discharge characteristic which relates OCV to RSOC. According to our findings, it has been found that neither the temperature nor the deterioration degree of the rechargeable battery 1 does not have sufficient influence on the discharge characteristic of relationship of RSOC to OCV.

Accordingly, it is possible to accurately calculate the remaining capacity at return from shutdown by using the certain relationship between the open voltage and the capacity of the rechargeable battery.

Also, the remaining capacity of the rechargeable battery can be calculated by the remaining capacity calculating device.

Therefore, it is possible to provide the battery pack with the remaining capacity calculating device capable of calculating the remaining capacity with small difference between the calculated remaining capacity and the actual remaining capacity when the battery returns from shutdown after being shut down and sitting unused.

Also, in shipment adjustment, the battery pack is charged before shipment. Accordingly, the control circuit board is activated. After that, the control circuit board is shut down. As a result, even if the battery pack sits unused for a long time after shipment, it is possible to accurately calculate the remaining capacity at the start of use.

Although, the RSOC data is created as remaining capacity data and is transmitted through the communication portion 9 in this first embodiment, the present invention is not limited to this. For example, the remaining capacity data can be created from RC which is obtained by multiplying RSOC by FCC, and can be transmitted through the communication portion 9.

### Second Embodiment

It has been described that the remaining capacity is newly calculated at return from shutdown in the first embodiment. In a second embodiment, a stored remaining capacity is reduced in accordance with the difference of the date and time data obtained before and after shutdown. In this second embodiment, the consumption current as discharging current of the battery pack 10 is substantially constant which is consumed by the electric device 20. Accordingly, the remaining capacity is displayed as the remaining time which is available to use the battery pack 10 mounted to the electric device 20.

It is found that the remaining capacity of the battery pack 10 decreases by about 17 minutes, which is converted as available time to use the battery pack 10 in the electric device 20, due to self-discharging of the rechargeable battery 1 with every 24 months after the battery pack 10 is shut down and sits unused. The remaining capacity is corrected by reducing the remaining capacity by 0.7 minute (≈17/24) every when one month elapses after shutdown. In other words, the remaining capacity is corrected by reducing the remaining capacity by a capacity represented by (consumption current)×(time) [Ah].

The remaining capacity is calculated and corrected on the condition that the consumption current consumed by the electric device 20 is substantially constant. However, needless to say, the aforementioned rate 0.7 minute/month can be changed on the condition that the consumption current is different from the aforementioned condition.

In this second embodiment, when the request command for shutdown is received through the communication portion 9, the remaining capacity which is stored in the RAM 53, is stored into the ROM 52, and the date and time data is obtained through the communication portion 9 and is stored into the ROM 52. Subsequently, the control circuit board 100 is shut down. When the battery pack returns from shutdown, the date and time data is obtained through the communication portion 9 at the initial remaining capacity inquiry. The shutdown period is obtained by subtracting the stored date and time data from the obtained date and time data. The correction capacity is calculated by multiplying the shutdown period by 0.7. The remaining capacity is calculated by subtracting the correction capacity from the stored remaining capacity.

The construction of the battery pack 10 according to the second embodiment is the same as the first embodiment. Therefore, the description of the construction of the battery pack 10 according to the second embodiment is omitted for the sake of brevity.

The operation of the aforementioned control portion 5 of the battery pack 10 is now described with reference to flowcharts showing this operation. The following procedures are performed by the CPU 51 based on the control program which is previously stored in the ROM 52.

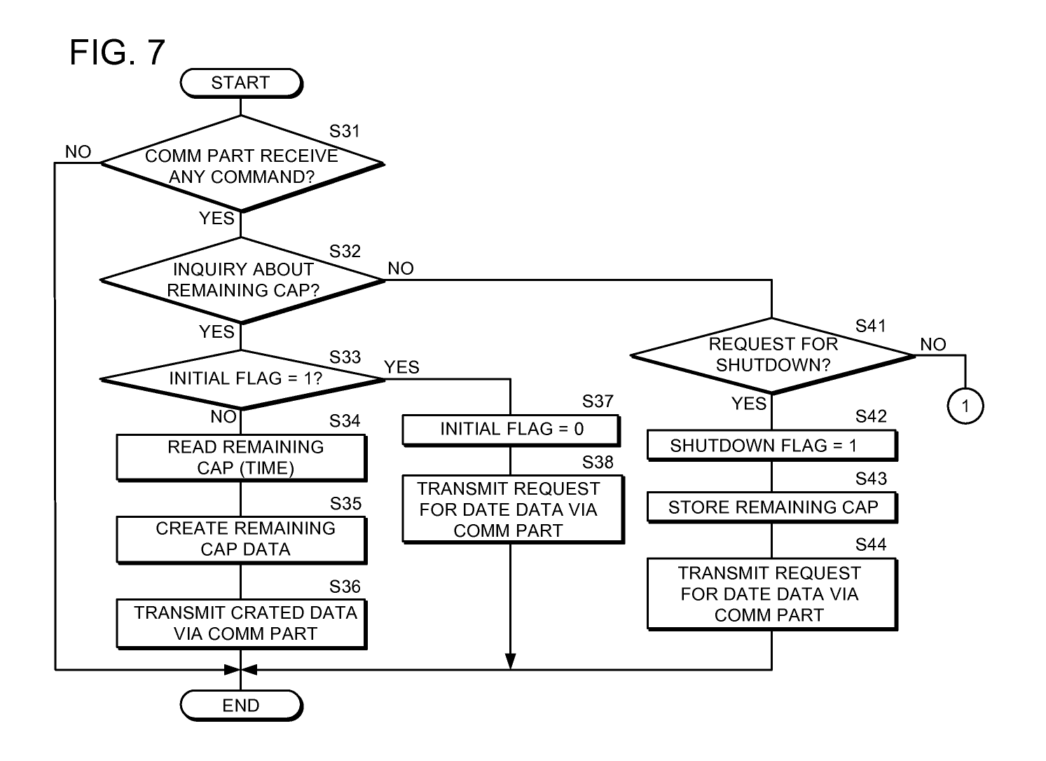

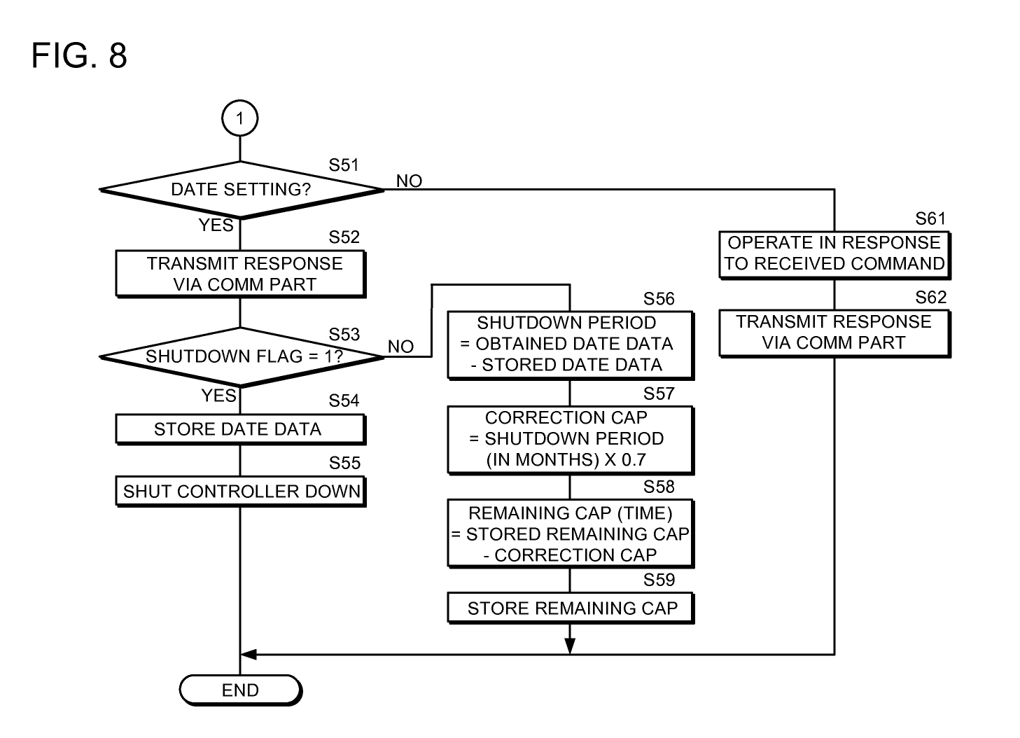

FIGS. 7 and 8 are the flowchart showing the procedures of the CPU 51 which executes processing based on commands received through the communication portion 9 in the battery pack according to the second embodiment of the present invention. The procedure of FIG. 7 starts periodically at a period (e.g., 1 sec) shorter than the polling period interrogated by the control/power-supply portion 21. However, the present invention is not limited to this period. An initial flag used in this embodiment is set to 1 (one) in initialization processing when the battery pack returns from shutdown. A shutdown flag is set to 1 when the shutdown request is received through the communication portion 9.

When the process shown in FIG. 7 starts, the CPU 51 determines whether the communication portion 9 receives any command (S31). If no command is received (S31: NO), the procedure FIG. 7 ends. If any command is received (S31: YES), the CPU 51 determines whether the received command is an inquiry command about remaining capacity (S32). If the received command is the inquiry command (S32: YES), the CPU 51 determines whether the initial flag is set 1, in other words, whether the inquiry command is received for the first time after the battery pack returns from shutdown (S33).

If the initial flag is not set 1 (S33: NO), in other words, if the inquiry command is received for the second time or later, the CPU 51 reads the remaining capacity (remaining time) from the RAM 53 (S22), and creates the remaining capacity data (S35). Subsequently, the created data is transmitted from the communication portion 9 (S36). After that, the procedure of FIG. 7 ends. If the initial flag is set 1 (S33: NO), in other words, if the inquiry command is received for the first time after the battery pack returns from shutdown, the CPU 51 resets the initial flag to zero (clears the initial flag) (S37), and transmits a date and time data request though the communication portion 9 (S38). After that, the procedure of FIG. 7 ends.

If it is not determined in Step S32 that the received command is the inquiry about remaining capacity (S32: NO), the CPU 51 determines whether the received command is a request command for shutdown (S41). If the received command is the request command for shutdown (S41: YES), the CPU 51 sets the shutdown flag to 1 (S42), and stores the remaining capacity which is stored in the RAM 53 into the ROM 52 of nonvolatile memory (S43). Subsequently, the date and time data request is transmitted from the communication portion 9 (S44). After that, the procedure of FIG. 7 ends.

The procedure of FIG. 8 is now described. If it is not determined that the received command is the request command for shutdown (S41: NO), the CPU 51 determines whether the received command is a date-and-time data setting command (S51). If the received command is a date-and-time data setting command (S51: YES), a response is transmitted from the communication portion 9 (S52). Subsequently, the CPU 51 determines whether the shutdown flag is set 1, in other words, whether the request command for shutdown has been received (S53). If the flag is set 1 (S53: YES), the ROM 52 stores the date and time data which is obtained when the date-and-time data setting command is received (S54). Subsequently, the MOSFET 61 is turned OFF so that the control circuit board 100 is shut down (S55). After that, the procedure of FIG. 7 ends.

If it is not determined in Step S53 that the shutdown flag is set 1 (S53: NO), the CPU 51 subtracts the date and time data which is stored in the ROM 52 from the date and time data which is obtained when the date-and-time data setting command is received to calculate the shutdown period (S56). Subsequently, the CPU 51 converts the calculated shutdown period into months, and multiplies the converted shutdown period in months by 0.7 to calculate a correction capacity (remaining time) in minutes (S57). In addition, the CPU 51 subtracts the calculated correction capacity in minutes from the remaining capacity which is stored in the ROM 52 to calculate the remaining capacity which is represented as the remaining time (S58), and stores the calculated remaining capacity into the RAM 53 (S59). After that, the procedure of FIG. 7 ends.

If it is not determined in Step 51 that the received command is the date-and-time data setting command (S51: NO), the CPU 51 performs processing corresponding to the received command (S61). Subsequently, a response is transmitted through the communication portion 9 (S62). After that, the procedure of FIG. 6 ends.

Components according to the second embodiment corresponding to the components the first embodiment are attached with the same reference numerals, and their description is omitted.

As discussed above, according to the second embodiment, the control circuit board includes a control portion for calculating the remaining capacity, and can calculate the correction capacity for correcting the remaining capacity so as to adjust the correction capacity higher or lower based on whether the difference is larger or smaller between the date and time data which is received through the communication portion and stored into the ROM before shutdown, and the date and time data which is received through the communication portion at return from shutdown. Thus, the remaining capacity can be obtained by subtracting the correction capacity from the remaining capacity which is stored in the ROM before shutdown.

Thus, it is possible to calculate the reduction amount for reducing the stored remaining capacity so as to adjust the reduction amount larger or lower based on whether the shutdown period is longer or shorter.

It has been described in the second embodiment that the date and time data is obtained through the communication portion 9, and the obtained date and time data is stored in the ROM 52 when the request command for shutdown is received through the communication portion 9. However, the present invention is not limited to this. For example, a clock IC can be provided which is constantly supplied with electric power from the rechargeable battery 1 so that the date and time data is obtained from this clock IC. During the control circuit board 100 is shut down, the clock IC is brought in a standby (HALT) status so that the date and time data is stored.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2011-109,803 filed in Japan on May 16, 2011, the content of which is incorporated herein by reference.

What is claimed is:

1. A method for calculating the remaining capacity of a rechargeable battery by using a calculation portion that is switched between ON and OFF, the method comprising:
obtaining the open voltage of said rechargeable battery after said calculation portion is switched from OFF to ON; and
calculating the remaining capacity of said rechargeable battery based on the obtained open voltage.

2. The remaining capacity calculating method according to claim 1 further comprising
storing the discharge characteristic which represents the relationship between the open voltage and the capacity of said rechargeable battery,
wherein the remaining capacity of said rechargeable battery is calculated based on the stored discharge characteristic and the obtained open voltage.

3. A method which stores the remaining capacity of a rechargeable battery and calculates the remaining capacity of the rechargeable battery by using a calculation portion that is switched between ON and OFF, the method comprising:
obtaining date and time data before and after said calculation portion is brought OFF;
calculating a correction capacity which is adjusted larger or smaller based on whether the difference between the obtained date and time data is larger or smaller; and
calculating the remaining capacity of said rechargeable battery by subtracting the calculated correction capacity from the stored remaining capacity.

4. A battery pack pre-shipment adjustment method comprising:
producing a battery pack which calculates the remaining capacity of a rechargeable battery by using the remaining capacity calculating method according to claim 1;
switching said calculation portion ON after the produced battery pack is charged from the external side before shipment; and
switching the calculation portion from ON to OFF.

5. A rechargeable battery remaining capacity calculating device comprising:
a rechargeable battery;
a calculation portion that is switched between ON and OFF; and
an open-voltage obtainer that obtains the open voltage of said rechargeable battery after said calculation portion is switched from OFF to ON,
wherein the remaining capacity of said rechargeable battery is calculated based on the open voltage, which is obtained by said open-voltage obtainer.

6. The remaining capacity calculating device according to claim 5 further comprising
a storage that stores the discharge characteristic which represents the relationship between the open voltage and the capacity of said rechargeable battery,
wherein the remaining capacity of said rechargeable battery is calculated based on the discharge characteristic, which is stored by said storage, and the open voltage, which is obtained by said open-voltage obtainer.

7. The remaining capacity calculating device according to claim 5 further comprising
a storage that stores the remaining capacity of the rechargeable battery;
a date-and-time obtainer that obtains date and time data before and after said calculation portion is brought OFF; and
a calculator that calculates a correction capacity which is adjusted larger or smaller based on whether the difference between the date and time data obtained by said date-and-time obtainer is larger or smaller,
wherein the remaining capacity of said rechargeable battery is calculated by subtracting the correction capacity, which is calculated by said calculator, from the remaining capacity which is stored by said storage.

8. A battery pack comprising:
the remaining capacity calculating device according to claim 5; and
one or more rechargeable batteries the remaining capacity of which is calculated by said remaining capacity calculating device.
